(19) United States
(12) Patent Application Publication
(10) Pub. No.: US 2011/0169784 A1
(43) Pub. Date: Jul. 14, 2011

(54) STYLUS RETAINING MECHANISM FOR PORTABLE ELECTRONIC DEVICE

(75) Inventors: SHAO-LIN YANG, Shenzhen (CN); HAN-YUN XIA, Shenzhen (CN); FENG-XIA WANG, Shenzhen (CN); MING WEI, Shenzhen (CN); FENG CHEN, Shenzhen (CN); YUE-XIANG HOU, Shenzhen (CN)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/826,806

(22) Filed: Jun. 30, 2010

(30) Foreign Application Priority Data
Jan. 14, 2010 (CN) 201010300298.X

(51) Int. Cl. G06F 3/033

(52) U.S. Cl. 345/179

(57) ABSTRACT

A stylus retaining mechanism for portable electronic device includes a main body, a latching portion, and an elastic member. The main body defines an opening and a receiving chamber communicating with the opening. The latching portion is positioned at one side of the receiving chamber spaced from the opening. The elastic member is fixed in the receiving chamber adjacent to the opening. The stylus is received in the receiving chamber. The elastic member prevents the stylus from separating from the main body when the stylus is disengaged from the latching portion.

### BACKGROUND

1. Technical Field

The exemplary disclosure generally relates to a stylus retaining mechanism, and, particularly, to a stylus retaining mechanism used in a portable electronic device.

2. Description of Related Art

Many portable electronic devices, such as palmtop computers, hand-held computers, laptop computers, mobile phones and personal digital assistants (PDAs), include a stylus or a touch pen. This can be utilized to input information into the electronic device, to select menu options or otherwise navigate through a touch control graphical user interfaces of an operating system or the current software application. Generally, the stylus is stored inside a housing of the portable electronic device. A stylus retaining mechanism is used to retain the stylus. A conventional stylus retaining mechanism includes a hook to lock the stylus. However, the stylus is easy to disengage from the hook when the portable electronic receives an impact, and may drop out of the housing by its own weight.

Therefore, there is room for improvement within the art.

### BRIEF DESCRIPTION OF THE DRAWINGS

Many aspects of the stylus retaining mechanism can be better understood with reference to the following drawings. The components in the drawings are not necessarily drawn to scale, the emphasis instead being placed upon clearly illustrating the principles of the stylus retaining mechanism, in which:

FIG. 1 is an assembled, isometric view of a stylus retaining mechanism with a stylus, in accordance with an exemplary embodiment.

FIG. 2 is an exploded, isometric view of the stylus retaining mechanism shown in FIG. 1.

FIG. 3 is an isometric view of the housing of the stylus retaining mechanism shown in FIG. 1.

FIG. 4 is an isometric view of the cover of the stylus retaining mechanism shown in FIG. 1.

FIG. 5 is a cross-sectional view of the stylus retaining mechanism along line V-V of FIG. 1.

FIG. 6 is similar to FIG. 3, but showing the stylus attached to the housing.

FIG. 7 is similar to FIG. 6, but showing the stylus attached to the cover.

FIG. 8 is an enlarged view of a circled portion VIII of FIG. 5.

### DETAILED DESCRIPTION

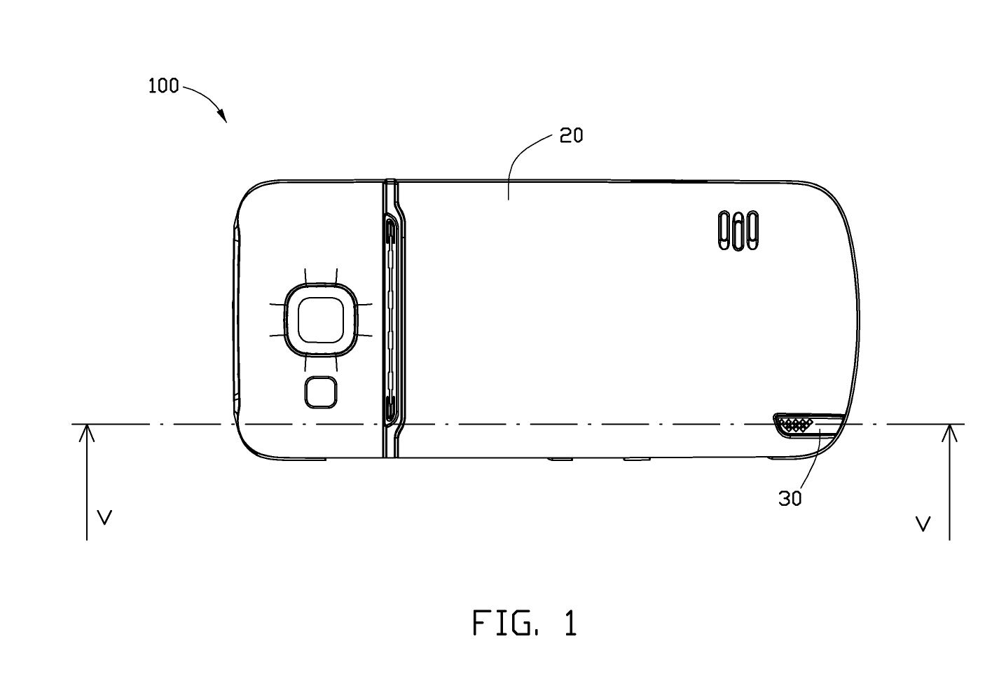

FIG. 1 shows an exemplary embodiment of a stylus retaining mechanism 100 applied to a portable electronic device (not labeled) for retaining a stylus 30.

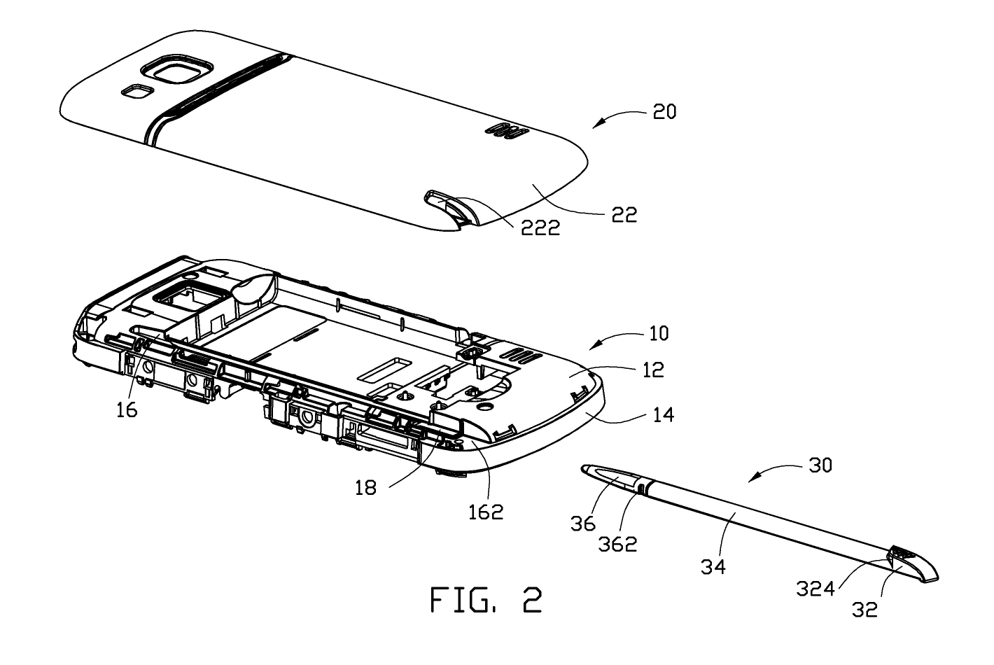

Referring to FIG. 2, the stylus 30 includes a head portion 32, an end portion 36 and a cylindrical middle portion 34 connecting the head portion 32 and the end portion 36. A step 324 is formed between the head portion 32 and the middle portion 34. The end portion 36 defines latching groove 362 in a peripheral surface thereof adjacent to one end of the middle portion 34.

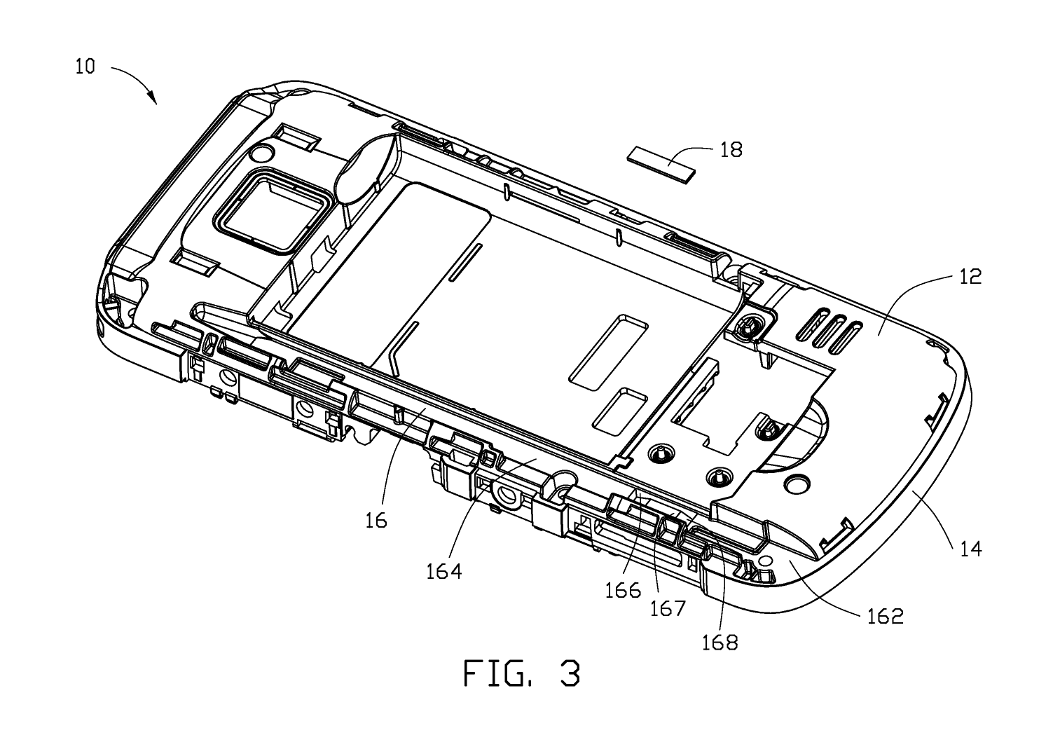

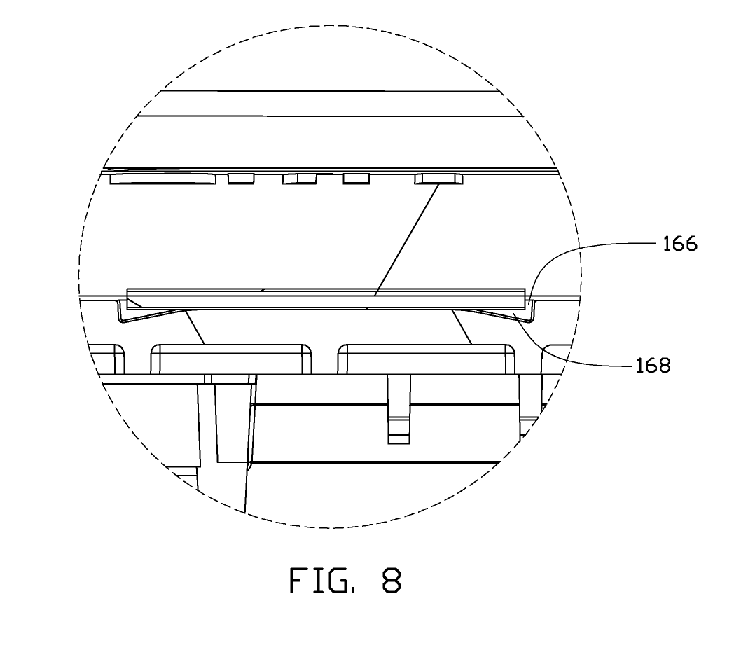

Referring to FIG. 3, the stylus retaining mechanism 100 includes a housing 10 and a cover 20. The housing 10 includes a top surface 12, and an end wall 14. A longitudinal recessed portion 16 is defined at one side of the top surface 12. The recessed portion 16 communicates to the end wall 14 and includes a bottom surface 164. Also referring to FIG. 8, a receiving groove 166 is defined in the bottom surface 164 adjacent to the end wall 14. A lower surface 167 is under the receiving groove 166, and two ends of the lower surface 167 slope down to form two notches 168. An elastic plate 18 is received in the receiving groove 166. In this embodiment, the elastic plate 18 is made of rubber and is attached to the receiving groove 166 by glue. The elastic plate 18 prevents the stylus 30 from dropping out by its own weight. Thus, the friction coefficient of the elastic plate 18 is designed to not affect to the ability to attach or detach the stylus 30 from the stylus retaining mechanism 100.

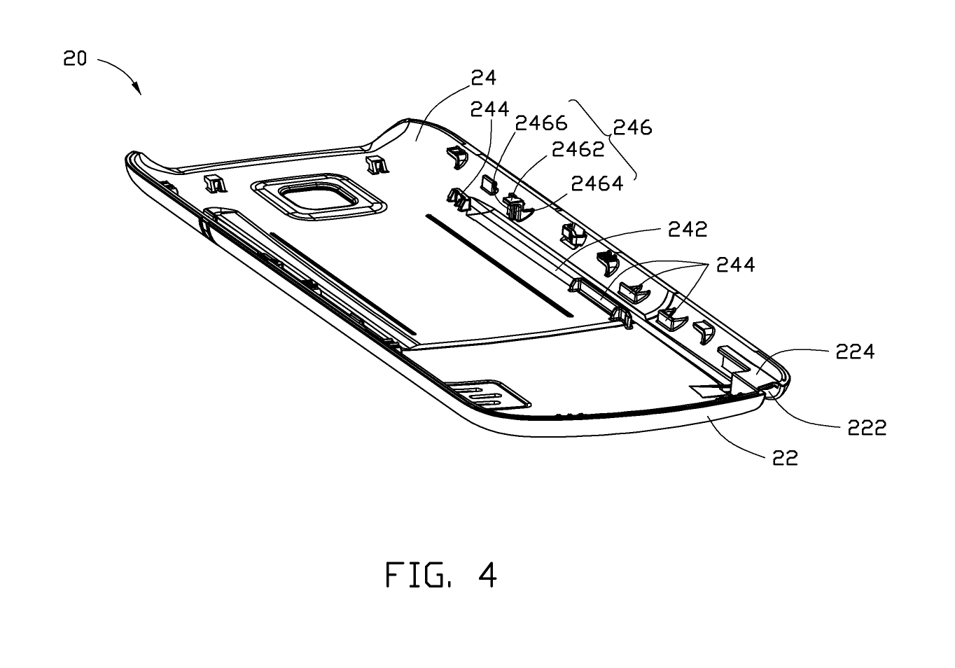

Referring to FIG. 4, the cover 20 includes a rear wall 22, an inner surface 24 and defines a longitudinal slot 242 corresponding to the cover 20. A restricting portion 224 extends from an inner side of the rear wall 22. The rear wall 22 and the restricting portion 224 cooperate to define an opening 222 allowing the stylus 30 to be inserted. A plurality of positioning blocks 244 are positioned at two sides of the slot 242 for retaining the stylus 30. A hook 246 is positioned at one side of the slot 242 away from the opening 222. The hook 246 includes a horizontal portion 2462, a vertical portion 2464 and a rib 2466 formed on the vertical portion 2464. The rib 2466 faces the slot 242 for engaging with the latching groove 362 of the stylus 30.

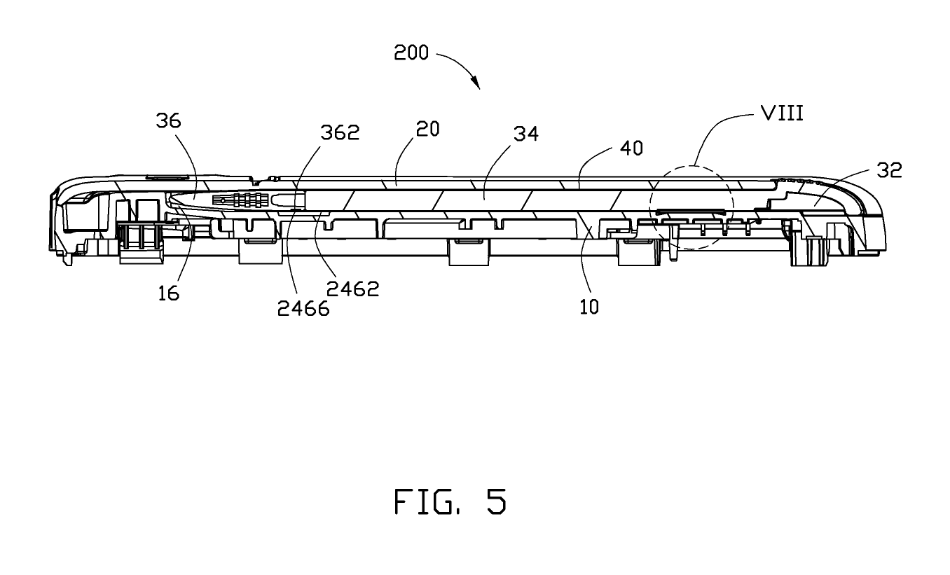

Referring to FIG. 5, when the cover 20 is attached to the housing 10, the slot 242 and the recessed portion 16 cooperate to define a receiving chamber 40 for receiving the stylus 30. The restricting portion 224 clings to the bottom surface 164.

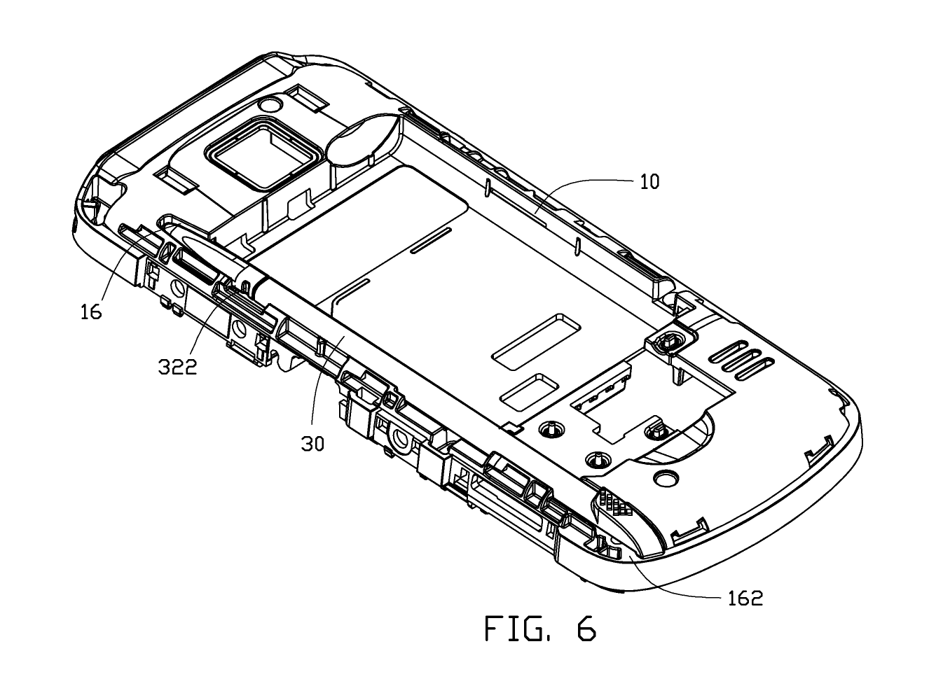

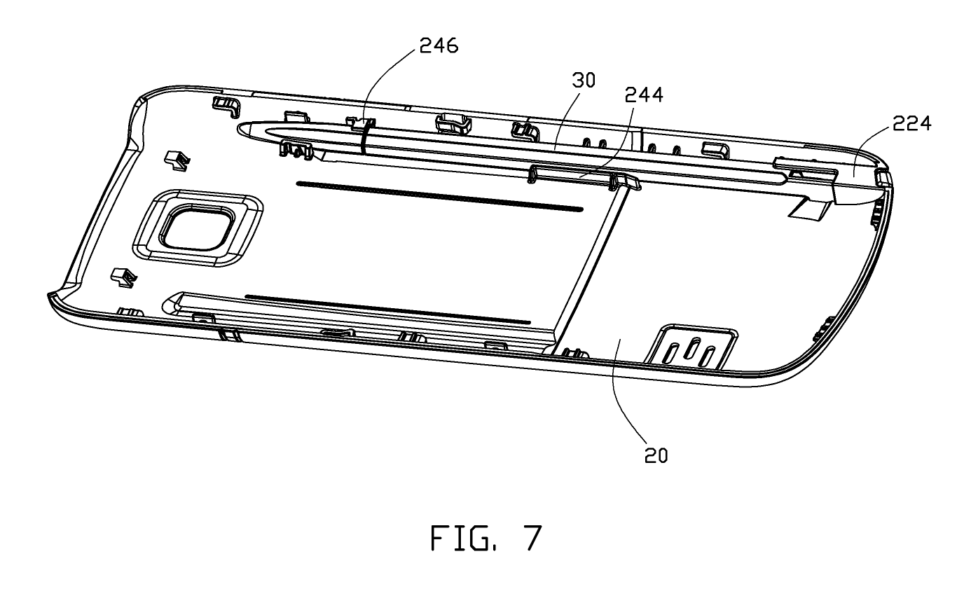

Also referring to FIGS. 6-8, to attach the stylus 30 to the stylus retaining mechanism 100, the end portion 36 is inserted into the receiving chamber 40 through the opening 222. The stylus 30 is pushed until the rib 2466 of the hook 246 engages the latching groove 362. When the stylus 30 contacts the elastic member 18, opposite ends of the elastic member 18 are respectively pushed into the notches 168. Pushing the opposite ends of the elastic member 18 into the notches 168 can prevent the opposite ends of the elastic member 18 from being caught by and rolled over by the stylus as the stylus is either inserter or removed. During the movement of the stylus 30, a friction force is formed between the stylus 30 and the elastic member 18. However, this friction force between the stylus 30 and the elastic member 18 is designed to prevent the stylus 30 from dropping out by its own weight, and does not affect ability to attach or detach the stylus 30 from the stylus retaining mechanism 100. When stylus 30 is received in the receiving chamber 40, the positioning blocks 244 and the restricting portion 224 stop the stylus 30 from moving left or right. The rib 2466 of the hook 246 and the elastic member 18 prevent the stylus 30 from moving front and back. The recessed portion 16 and the slot 242 limit the stylus 30 from moving up and down. Thus, the stylus 30 is positioned, with the head received in the opening 222.

To detach the stylus 30 from the stylus retaining mechanism 100, the stylus 30 is removed using the step 324. The stylus 30 is disengaged from the hook 246 and moves along the receiving chamber 40.

If the portable electronic device receives impact (e.g. gets dropped) and the stylus 30 is disengaged from the hook 246, a friction force between the elastic member 18 and the stylus 30 can prevent the stylus 30 from separating from the portable electronic device.

It is to be understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A stylus retaining mechanism for portable electronic device comprising:
a main body defining an opening and a receiving chamber communicating with the opening, the receiving chamber is configured to receive a stylus;
a latching portion positioned at one side of the receiving chamber spaced from the opening, the latching portion configured for latching the stylus;
an elastic member fixed in the receiving chamber adjacent to the opening, the elastic member preventing the stylus from separating from the main body when the stylus is disengaged from the latching portion.

2. The stylus retaining mechanism as claimed in claim 1, wherein the main body further defines a receiving groove communicating with the receiving chamber, and the receiving groove receives the elastic member.

3. The stylus retaining mechanism as claimed in claim 2, wherein the main body further comprises a lower surface under the receiving groove, and two ends of the lower surface slope down.

4. The stylus retaining mechanism as claimed in claim 1, wherein the main body further comprises a plurality of positioning blocks positioned at two sides of the receiving chamber to limit stylus movement.

5. The stylus retaining mechanism as claimed in claim 4, wherein the main body comprises a housing and a cover, the housing defines a recessed portion, the cover defines a longitudinal slot, and the recessed portion and the longitudinal slot cooperate to defines the receiving chamber.

6. The stylus retaining mechanism as claimed in claim 5, wherein the recessed portion includes a bottom surface, and the elastic member is fixed in the bottom surface.

7. The stylus retaining mechanism as claimed in claim 6, wherein the positioning blocks are formed on the cover and are positioned at two sides of the longitudinal slot.

8. The stylus retaining mechanism as claimed in claim 1, wherein the main body includes a rear wall, a restricting portion extends from an inner side of the rear wall, and the rear wall and the restrict portion cooperate to defines the opening.

9. The stylus retaining mechanism as claimed in claim 1, wherein the latching portion is a hook, the hooks includes a rib, the stylus defines a latching groove, and the rib is engaged in the latching groove when the stylus is locked in the receiving chamber.

10. The stylus retaining mechanism as claimed in claim 9, wherein the hook includes a horizontal portion and a vertical portion connected to teach other, and the rib is formed on the vertical portion.

11. A stylus retaining mechanism for portable electronic device comprising:
a housing defining a recessed portion, an elastic member fixed in the recessed portion; and
a cover attached to the housing, the cover defining a slot and including a latching portion adjacent to the slot, the latching portion configured for latching a stylus, the slot and the recessed portion cooperate to defining a receiving chamber to receive the stylus, the elastic member preventing the stylus from separating from the receiving chamber by its own weight when the stylus is disengaged from the latching portion.

12. The stylus retaining mechanism as claimed in claim 11, wherein the housing further defines a receiving groove communicating with the receiving chamber, and the receiving groove receives the elastic member.

13. The stylus retaining mechanism as claimed in claim 12, wherein the housing further comprises a lower surface under the receiving groove, and two ends of the lower surface slope down.

14. The stylus retaining mechanism as claimed in claim 1, wherein the cover further comprises a plurality of positioning blocks positioned at two sides of the slot to limit stylus movement.

15. The stylus retaining mechanism as claimed in claim 11, wherein the cover comprises a rear wall, a restricting portion extends from an inner side of the rear wall, and the rear wall and the restrict portion cooperate to defines an opening.

16. The stylus retaining mechanism as claimed in claim 15, wherein the elastic member is positioned adjacent to the opening.

17. The stylus retaining mechanism as claimed in claim 11, wherein the latching portion is a hook, the hooks includes a rib, the stylus defines an latching groove, and the rib is engaged in the latching groove when the stylus is locked in the receiving chamber.

18. The stylus retaining mechanism as claimed in claim 17, wherein the hook includes a horizontal portion and a vertical portion connected to teach other, and the rib is formed on the vertical portion.

19. A portable electronic device comprising:
a stylus defining an annular groove; and
a main body defining an opening and a receiving chamber communicating with the opening, the stylus received in the receiving chamber;
a latching portion positioned at one side of the receiving chamber spaced from the opening, the latching portion including a rib engaged in the latching groove of the stylus;
an elastic member fixed in the receiving chamber adjacent to the opening, the elastic member preventing the stylus from separating from the main body by its own weight when the rib is disengaged from the latching groove.

20. The stylus retaining mechanism as claimed in claim 19, wherein the portable electronic device further defines a receiving groove communicating with the receiving chamber, and the receiving groove receives the elastic member.
